(19) United States
(12) Patent Application Publication
(10) Pub. No.: US 2025/0155592 A1
(43) Pub. Date: May 15, 2025

(54) EARTHQUAKE DETECTION AND MONITORING USING SMART UTILITY METERS

(71) Applicant: ITRON, INC., Liberty Lake, WA (US)

(72) Inventors: Craig Arnold NEWMAN, Glendale, CA (US); Yacine KHALED, Meudon (FR); Fabrice MONIER, Bry-sur-Marne (FR)

(21) Appl. No.: 18/510,467

(22) Filed: Nov. 15, 2023

(51) Int. Cl. G01V 1/00; G01P 15/18

(52) U.S. Cl. CPC G01V 1/01; G01P 15/18

(57) ABSTRACT

Various embodiments disclose a method comprising generating, by a metering device, first metrology data indicative of a value of a ground acceleration proximate the metering device and generating, by the metering device, second metrology data indicative of a direction of the ground acceleration proximate the metering device. The method further comprises determining, by the metering device based on the first metrology data, that a condition indicative of an earthquake has been satisfied and in response to determining that the condition indicative of an earthquake has been satisfied, transmitting, by the metering device, a message associated with the first metrology data and the second metrology data to a computing device.

### BACKGROUND

### Field of the Various Embodiments

The various embodiments relate generally to earthquake detection, and more specifically, to detecting earthquakes using smart utility meters.

### Description of the Related Art

Smart utility meters electronically record the consumption of utility commodities, such as water, electricity, heat, and gas, and transmit metrology data indicative of the recorded commodity consumption to other devices. For example, for billing purposes, a smart utility meter transmits metrology data indicative of consumption of a utility commodity to a remote computing device of a utility provider. Many smart utility meters also include sensors that are used to detect when someone is tampering with the smart utility meter. As an example, a smart utility meter, such as an electricity meter, can include an accelerometer that is used to detect when someone is attempting to remove or otherwise move the smart utility meter. As another example, a smart utility meter, such as an electricity meter, can include a magnetometer that is used to detect when someone is using a magnet to alter the measurements of electricity consumption that are generated by the smart utility meter.

### BRIEF DESCRIPTION OF THE DRAWINGS

So that the manner in which the features of the various embodiments can be understood in detail, a description of the inventive concepts may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of an earthquake detection and monitoring system, according to various embodiments;

FIG. 2 illustrates a metering device, according to various embodiments;

FIG. 3 illustrates a perspective view of the metering device of FIG. 2, according to various embodiments.

FIG. 4 illustrates a waveform associated with ground acceleration in a first direction, according to various embodiments.

FIG. 5 illustrates a waveform associated with ground acceleration in a second direction, according to various embodiments.

FIG. 6 illustrates a computing device, according to various embodiments.

FIG. 7 is a flow diagram of method steps for detecting an earthquake, according to various embodiments.

FIG. 8 is a flow diagram of method steps for determining a characteristic of an earthquake, according to various embodiments.

FIG. 9 illustrates a network system configured to implement one or more aspects of the various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

Earthquakes pose serious risks to human life and can cause significant damage to infrastructure. For example, as the ground shakes during an earthquake, buildings, bridges, roads, and other infrastructure can become damaged and even collapse. Such extensive damage to infrastructure can disrupt essential services such as the distribution of electricity, water supply, and communication systems, thereby making it challenging to effectively respond to earthquake-related emergencies.

To mitigate the above-described dangers associated with earthquakes, various systems for detecting the occurrence of an earthquake have been developed. One example of an earthquake detection system, ShakeAlert®, provided by the US Geological Service has been employed in the western United States. ShakeAlert is an early detection system, meaning that in operation, ShakeAlert® can detect the occurrence of an earthquake and notify a nearby city shortly before arrival of the earthquake. For example, during an earthquake, a rupturing fault emits a fast-moving P-wave and a slow, later-arriving S-wave. Sensors included in the ShakeAlert® system can detect the P-wave and immediately transmit sensor data to a processing center at which the location, size, and estimated shaking of the earthquake are determined. The processing center then transmits messages that notify people in nearby cities of the impending earthquake (e.g., 30 seconds to a minute before arrival of the earthquake) so that the people can take protective action. ShakeAlert® can also transmit messages that trigger an automated action, such as slowing down a train or shutting off a utility, in response to detecting an earthquake.

Although early detection systems, such as ShakeAlert®, are effective at notifying people of the immediate arrival of an earthquake, such systems are less effective at providing localized earthquake information for monitoring services and helping assess areas that were most damaged by the earthquake. For example, sensors in early detection systems such as ShakeAlert® are often located miles away from cities, and thus, measurements generated by the sensors do not provide much insight as to whether particular buildings, roads, or other infrastructure within a city are more damaged than others. Therefore, ShakeAlert® is not useful for identifying which areas should be targeted first by first responders. In addition, early detection systems such as ShakeAlert® can be expensive to install and maintain, as these systems include numerous standalone sensors, such as seismometers, which are installed in remote locations that are far away from city centers. Accordingly, installation of early detection systems, such as ShakeAlert®, is often limited to areas in which earthquakes occur frequently enough to justify the cost of such systems. Therefore, earthquakes that occur in areas in which earthquakes occur less frequently often go undetected.

In order to address these shortcomings, techniques are disclosed herein that enable smart utility meters to detect the occurrence of an earthquake. As described above, many smart utility meters include sensors, such as accelerometers and directional sensors, that are used to detect when someone is tampering with the smart utility meter. Accordingly, with the disclosed techniques, measurements generated by the accelerometers and directional sensors included in smart utility meters can be used to detect the occurrence of an earthquake and estimate a magnitude, an intensity, a location, and/or a direction associated with the earthquake.

In some embodiments, an accelerometer included in a metering device, such as a smart utility meter, generates first metrology data indicative of the ground acceleration proximate the location of the metering device. Further, a directional sensor, such as a magnetometer or some other sensor configured to function as an electronic compass, included in the metering device generates second metrology data indicative of one or more directions of the ground acceleration proximate the metering device. The metering device then determines, based on the first metrology data, whether a condition indicative of an earthquake has been satisfied. For example, the metering device determines whether a characteristic of the ground acceleration proximate the metering device exceeds one or more thresholds associated with an earthquake. In response to determining that a condition indicative of an earthquake has been satisfied, the metering device can transmit a message that includes the first metrology data and the second metrology data to a computing device that determines a characteristic of an earthquake that has occurred. In some examples, the computing device determines one or more of a magnitude, an intensity, and/or a location associated with an earthquake based on the first and second metrology data. In some examples, the computing device determines values of ground acceleration in one or more directions relative to the metering device based on the first and second metrology data.

The magnitude of an earthquake refers to the amount of energy that is released during the earthquake and can be described as a numeric value using the Richter scale. The magnitude of an earthquake does not depend on where a measurement associated with the earthquake (e.g., ground acceleration measurement) was taken. The intensity of an earthquake refers to an amount of shaking that occurs at a particular location during an earthquake. The intensity of an earthquake at a particular location can be described numerically using an intensity scale, such as the modified Mercalli scale or the Rossi-Forel scale. A location associated with an earthquake can refer to the hypocenter of the earthquake and/or the epicenter of the earthquake, where the hypocenter is a location below earth's surface where the earthquake starts and the epicenter is the location on earth's surface directly above the hypocenter. A location associated with an earthquake can also be a location that has been subjected to a high intensity during the earthquake where destruction of infrastructure, loss of supply of utility commodities, and/or human casualty are likely to be higher.

As will be described in more detail herein, a metering device and/or a computing device can determine one or more values of ground acceleration occurring in one or more directions relative to the metering device. In some examples, the accelerometer included in a metering device measures ground acceleration along one or more axes, such as along an x-axis, a y-axis, and a z-axis, and the directional sensor measures a direction in which the metering device is oriented. Based on the ground acceleration measured along one or more axes and the direction in which the metering device is facing, the metering device and/or a computing device can determine values of ground acceleration in one or more directions, such as one or more cardinal directions, one or more ordinal directions, or one or more other directions relative to Earth's magnetic north, relative to the metering device. In one example, the metering device and/or a computing device determines values of ground acceleration in the east-west direction, the north-south direction, and the up-down direction relative to the metering device based on the ground acceleration measured along one or more axes and the direction in which the metering device is facing.

In some embodiments, a computing device, such as a remote computing device of a utility provider or a third-party service that monitors earthquake activity, receives metrology data indicative of ground acceleration from a plurality of metering devices. For example, the computing device receives a first message that includes metrology data associated with a ground acceleration at a first location from a first metering device. Further, the computing device receives a second message that includes metrology data associated with a ground acceleration at a second location from a second metering device. Then, the computing device determines, based at least on the ground acceleration at the first location and the ground acceleration at the second location, one or more of a characteristic of an earthquake that has occurred.

At least one technical advantage of the disclosed techniques is that, with the disclosed techniques, earthquakes can be detected and classified without the use of expensive early detection systems based on seismometers. In this regard, the disclosed techniques utilize sensors, such as accelerometers and directional sensors, which are included in smart utility meters for tamper detection to generate metrology data indicative of the ground acceleration proximate the smart utility meters. Moreover, by analyzing the metrology data indicative of the ground acceleration proximate the smart utility meters, the disclosed techniques are capable of detecting an occurrence of an earthquake and determining one or more characteristics, such as a magnitude, an intensity, a direction, and/or a location associated with the earthquake. Another technical advantage of the disclosed techniques is that, with the disclosed techniques, areas that have been subjected to higher earthquake intensities and are likely to be most in need of first responders after an earthquake can be quickly identified based on the metrology data indicative of ground acceleration that is generated by smart utility meters. In this regard, as smart utility meters are installed in many buildings or other infrastructure within a city, metrology data indicative of ground acceleration that is generated by the smart utility meters can be used to identify which buildings or other pieces of infrastructure are more likely to have been damaged more than others by an earthquake.

### Detecting and Monitoring an Earthquake Using Smart Utility Meters

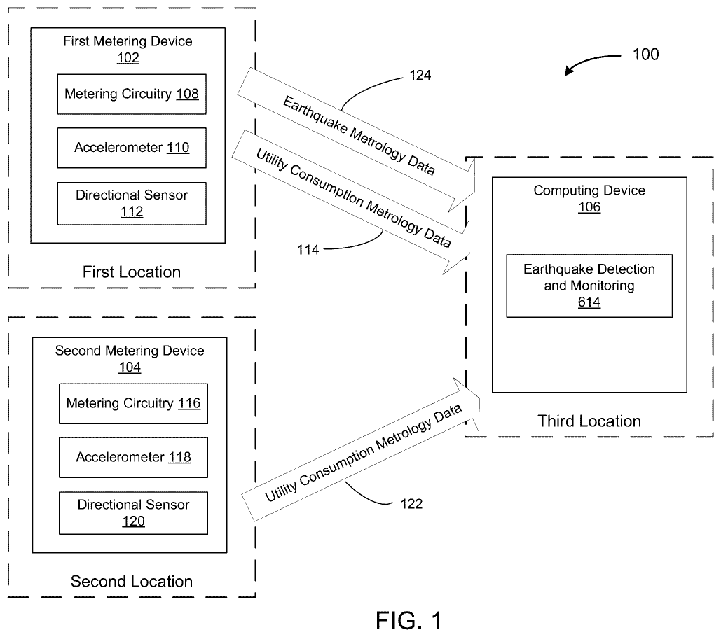

Referring now to FIG. 1, a block diagram of an earthquake detection and monitoring system 100 is shown. As shown in FIG. 1, earthquake detection and monitoring system 100 includes, without limitation, a first metering device 102, a second metering device 104, and a computing device 106. In operation, first and second metering devices 102, 104 are configured to monitor and report consumption of utility commodities to computing device 106. For example, first and second metering device 102, 104 generate and transmit metrology data indicative of utility commodity consumption to computing device 106. In addition, first and second metering devices 102, 104 are further configured to detect and monitor earthquakes based on metrology data generated by respective accelerometers and/or directional sensors, such as magnetometers or other sensor configured to act as electronic compasses, included in first and second metering devices 102, 104. In response to determining that an earthquake has occurred based on metrology data generated by a respective accelerometer and/or a respective directional sensor, a respective metering device 102, 104 transmits metrology data indicative of the occurrence of an earthquake to computing device 106. Although not shown in FIG. 1, first and second metering devices 102, 104 can also share metrology data with each other. For example, first metering device 102 can transmit metrology data indicative of the consumption of a utility commodity and/or metrology data indicative of the occurrence of an earthquake to second metering device 104.

Devices 102, 104, and 106 are connected by a communication medium (not shown). The communication medium can be, for example, a wired connection (e.g., an Ethernet connection or a power line communication connection), a wireless connection (e.g., a Wi-Fi connection, a Bluetooth connection, or any other type of wireless connection), or any combination thereof. As shown in FIG. 1, first metering device 102 is located at a first location, such as a first building or structure at which one or more utility commodities are consumed and second metering device 104 is located at a second location, such as a second building or structure at which one or more utility commodities are consumed. In some examples, computing device 106 is a server or similar computing device located at a third location, such as an office or other facility of a utility provider, a third-party service associated with monitoring earthquake activity, and/or an emergency service provider (e.g., police station, fire station, call center, etc.). In other examples, computing device 106 is another metering device located at a third location, such as a second building or structure at which one or more utility commodities are consumed. In some examples, computing device 106 is implemented as a different type of network device, such as a network-connected streetlight that includes a network-connected controller or similar device. Although not shown, devices 102, 104, and 106 can be in communication with other devices by the same communication medium or different communication media.

As shown in FIG. 1, first metering device 102 includes, without limitation, metering circuitry 108, an accelerometer 110, and a directional sensor 112 such as a magnetometer or similar sensor configured to function as an electronic compass. In operation, first metering device 102 can perform functions such as using metering circuitry 108 to monitor consumption of a utility commodity, using metering circuitry 108 to generate metrology data indicative of the consumption of a utility commodity, storing the metrology data indicative of the consumption of a utility commodity, and/or transmitting the metrology data indicative of the consumption of a utility commodity to one or more other devices. For example, first metering device 102 uses metering circuitry 108 to monitor consumption of a utility commodity, such as water, gas, heat, or electricity, at a first location and transmits metrology data indicative of the consumption of the utility commodity to one or more other devices. In the illustrated example of FIG. 1, first metering device 102 transmits a message that includes utility consumption metrology data 114 to computing device 106.

As further shown in FIG. 1, second metering device 104 includes, without limitation, metering circuitry 116, an accelerometer 118, and a directional sensor 120 such as a magnetometer or similar sensor configured to function as an electronic compass. In operation, second metering device 104 can perform functions such as using metering circuitry 116 to monitor consumption of a utility commodity, using metering circuitry 116 to generate metrology data indicative of the consumption of a utility commodity, storing the metrology data indicative of the consumption of a utility commodity, and/or transmitting the metrology data indicative of the consumption of a utility commodity to one or more other devices. For example, second metering device 104 uses metering circuitry 116 to detect consumption of a utility commodity, such as water, gas, heat, or electricity, at a second location and transmits metrology data indicative of the consumption of the utility commodity to one or more other devices. In the illustrated example of FIG. 1, first metering device 102 transmits a message that includes utility consumption metrology data 122 to computing device 106.

As will be described in more detail herein, first and second metering devices 102, 104 can further perform functions related to detecting and monitoring earthquakes. In operation, first metering device 102 can use accelerometer 110 to sense ground acceleration in one or more directions and generate metrology data indicative of the ground acceleration in one or more directions. Accelerometer 110 can be a three-axis accelerometer that measures ground acceleration along each of the three axes. Furthermore, in operation, first metering device 102 can use directional sensor 112 to generate metrology data indicative of a compass heading, or direction, in which first metering device 102 is facing. First metering device 102 can determine values of ground acceleration proximate first metering device 102 along one or more directions (e.g., north-south, east-west, up-down, etc.) relative to the first location at which first metering device 102 is installed based on the metrology data generated by accelerometer 110 and/or directional sensor 112. In some examples, first metering device 102 is instead implemented as a streetlight that includes a network-connected controller or similar network device that can detect and monitor earthquakes.

In addition, based on the metrology data generated by accelerometer 110 and/or the directional sensor 112, first metering device 102 can determine whether one or more conditions indicative of an earthquake are satisfied. A condition indicative of an earthquake can be satisfied when, for example, one or more values of the ground acceleration at the first location exceed a threshold value and/or a frequency associated with the ground acceleration at the first location exceeds a threshold. In response to determining that a condition indicative of an earthquake has been satisfied, first metering device 102 transmits one or more messages including metrology data indicative of the occurrence of an earthquake to computing device 106. In the illustrated example of FIG. 1, first metering device 102 transmits a message that includes earthquake metrology data 124 to computing device 106, where the earthquake metrology data 124 includes metrology data generated by accelerometer 110 and/or directional sensor 112 that is indicative of the occurrence of an earthquake. Although not shown, in some examples, first metering device 102 transmits one or more messages that include earthquake metrology data 124 to other devices, such as second metering device 104. Messages transmitted by first metering device 102 and that include earthquake metrology data 124 can include additional information, such as information indicative of the first location at which the earthquake metrology data 124 was generated and/or a notification that an earthquake has occurred.

Similar to first metering device 102, second metering device 104 can use accelerometer 118 to sense ground acceleration in one or more directions and generate metrology data indicative of the ground acceleration in one or more directions. Accelerometer 118 can be a three-axis accelerometer that measures ground acceleration along each of the three axes. Furthermore, in operation, second metering device 104 can use directional sensor 120 to generate metrology data indicative of a compass heading, or direction, in which second metering device 104 is facing. Second metering device 104 can determine values of ground acceleration proximate second metering device 104 along one or more directions (e.g., north-south, east-west, up-down, etc.) relative to the second location at which second metering device 104 is installed based on the metrology data generated by accelerometer 118 and/or directional sensor 120. In some examples, second metering device 104 is instead implemented as a streetlight that includes a network-connected controller or similar network device that can detect and monitor earthquakes.

In addition, based on the metrology data generated by accelerometer 118 and/or directional sensor 120, second metering device 104 can determine whether one or more conditions indicative of an earthquake are satisfied. A condition indicative of an earthquake can be satisfied when, for example, one or more values of the ground acceleration at the first location exceed a threshold value and/or a frequency associated with the ground acceleration at the first location exceeds a threshold. In response to determining that a condition indicative of an earthquake has not been satisfied, second metering device 104 refrains from transmitting a message that includes metrology data generated by accelerometer 118 and/or directional sensor 120 to computing device 106. In the illustrated example of FIG. 1, second metering device 104 does not transmit a message that includes earthquake metrology data to computing device 106 because second metering device 104 did not determine that one or more conditions indicative of an earthquake have been satisfied.

In operation, computing device 106 receives messages that include metrology data from first and second metering devices 102, 104. In the illustrated example of FIG. 1, computing device 106 receives a message that includes utility consumption metrology data 114 from first metering device 102, receives a message that includes utility consumption metrology data 122 from second metering device 104, and receives a message that includes earthquake metrology data 124 from first metering device 102. In response to receiving messages that include metrology data indicative of the occurrence of an earthquake, such as earthquake metrology data 124, from one or more metering devices, computing device 106 can determine one or more characteristics, such as a magnitude, an intensity, a direction, and/or a location, of an earthquake that has occurred based on the received metrology data. For example, computing device 106 executes an earthquake and detection monitoring application 614 that determines one or more characteristics associated with an earthquake based on received metrology data indicative of the occurrence of an earthquake.

Computing device 106 can further perform one or more actions in response to determining one or more characteristics associated with the earthquake. In some examples, in response to determining a location that has been subjected to a high intensity during the earthquake where destruction of infrastructure, loss of supply of utility commodities, and/or human casualty are likely to be higher, computing device 106 transmits one or more messages identifying the location to one or more computing devices associated with emergency service providers (e.g., police station, fire station, etc.) and/or utility providers. In some examples, computing device 106 can shut off the supply of one or more utility commodities at a location in response to determining that the location has been subjected to a high intensity during the earthquake. In some examples, computing device 106 can monitor the health of infrastructure at locations that have been subjected to a high intensity during the earthquake, assess and manage risk associated with locations impacted by an earthquake, and/or be implemented earthquake-related research.

### Metering Device

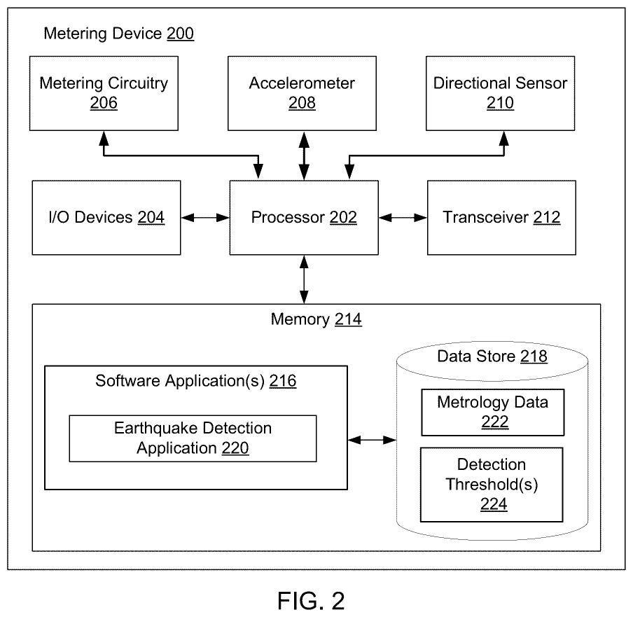

FIG. 2 illustrates a metering device 200, according to various embodiments. In some embodiments, metering device 200 is used to implement any of first metering device 102 or second metering device 104 of FIG. 1. In some embodiments, metering device 200 is used to implement computing device 106 of FIG. 1. In some embodiments, metering device 200 is instead implemented as a streetlight that includes a network-connected controller or similar network device. As shown, metering device 200 includes, without limitation, processor 202, input/output (I/O) devices 204, metering circuitry 206, accelerometer 208, directional sensor 210, transceiver 212, and memory 214, coupled together.

Processor 202 coordinates operations of metering device 200. In various embodiments, processor 202 includes any hardware configured to process data and execute software applications. The processor 202 can be any technically feasible processing device configured to process data and execute program instructions. For example, processor 202 could include one or more central processing units (CPUs), DSPs, graphics processing units (GPUs), application-specific integrated circuits (ASICs), field-programmable gate arrays (FPGAs), microprocessors, microcontrollers, other types of processing units, and/or a combination of different processing units. Processor 202 can include a real-time clock (RTC) (not shown) according to which processor 202 maintains an estimate of the current time. The estimate of the current time can be expressed in Universal Coordinated Time (UTC), although any other standard of time measurement can also be used.

I/O devices 204 include devices configured to receive input, devices configured to provide output, and devices configured to both receive input and provide output. Metering circuitry 206 includes one or more data acquisition devices that are used by metering device 200 to monitor consumption of a utility commodity (e.g., water, gas, electricity, etc.). For example, I/O devices 204 can further include one or more of an electricity meter, a gas meter, a water meter, or some other type of sensor used to monitor consumption of a utility commodity.

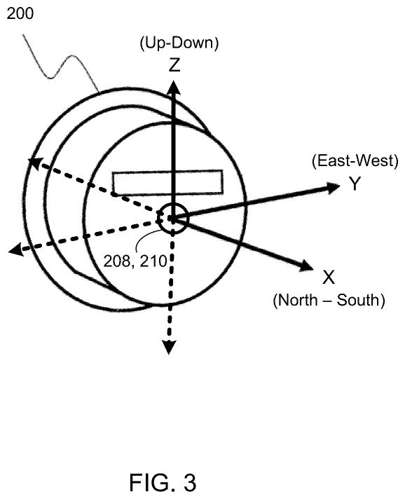

Accelerometer 208 is configured to sense movement, or acceleration, of metering device 200. In some examples, accelerometer 208 senses acceleration of metering device 200 along one or more axes. FIG. 3 illustrates a perspective view of the metering device 200 of FIG. 2. As shown in FIG. 3, accelerometer 208 can sense the acceleration along an x-axis relative to metering device 200, sense acceleration along a y-axis relative to metering device 200, and sense an acceleration along a z-axis relative to metering device. In some examples, the acceleration values sensed along each of the x, y, and z axes can be combined into an acceleration vector that is indicative of the movement, or acceleration, of metering device 200. As will be described in more detail below, the acceleration values sensed along each of the x, y, and z axes can be oriented with respect to a compass heading of metering device 200 and/or Earth's magnetic north.

Traditionally, metering devices, such as electricity meters or water meters, have included accelerometers for the purpose of detecting tampering with a metering device. For example, based on an acceleration sensed by accelerometer 208, metering device 200 can determine when someone is trying to remove metering device 200 form the premises at which metering device 200 monitors consumption of a utility commodity (e.g., electricity, water, or gas). However, as described above with respect to FIG. 1, metering device 200 can further determine whether an earthquake is occurring and/or has occurred based on an acceleration sensed by accelerometer 208. For example, when the ground shakes during an earthquake, the building or other structure at which metering device 200 is installed also shakes and/or moves during the earthquake. Accordingly, as the building and/or structure at which metering device 200 is installed shakes and/or moves during an earthquake, accelerometer 208 can sense this and generate measurements indicative of the ground acceleration proximate metering device 200.

Directional sensor 210, which can be implemented as a magnetometer or some other sensor configured to function as an electronic compass, is configured to sense the strength of the magnetic field proximate metering device 200. Traditionally, metering devices such as electricity meters have included directional sensors, such as magnetometers, for the purpose of detecting when someone is tampering with the monitoring of electricity consumption by a metering device. For example, someone might place a magnet near metering device 200 to alter the measurements of electricity consumption that are generated by metering circuitry 206 included in metering device 200. Based on the magnetic field strength measurements generated by directional sensor 210, metering device 200 can detect a change in the magnetic field strength proximate metering device 200 when someone places a magnet near metering device 200.

Measurements generated by directional sensor 210 can further be used to determine a compass heading of metering device 200. The compass heading of metering device 200 refers to the direction (e.g., north, south, east, west, northwest, northeast, southwest, or southeast) in which metering device 200 is facing. As shown in FIG. 3, in operation, directional sensor 210 senses the magnetic field strength proximate metering device 200 along three axes (e.g., an x-axis, a y-axis, and a z-axis). When there is no magnetic tampering occurring near metering device 200 (e.g., no magnet is present near metering device 200), the magnetic field strength measurements generated by directional sensor 210 are indicative of the strength of Earth's magnetic field proximate metering device 200. The magnetic field strength measurements along the x-axis and y-axis relative to metering device 200 (e.g., see FIG. 3), which are assumed to be planar to the surface of the Earth, can be used to determine the direction in which metering device 200 is facing.

In some examples, metering device 200 can use one or more known equations to determine, based on the magnetic field strength measurements along the x-axis and y-axis relative to metering device 200, a direction in degrees relative to Earth's magnetic poles in which metering device 200 is facing. In such examples, metering device 200 can determine the direction (e.g., north, south, east, west, northwest, northeast, southwest, or southeast) metering device 200 is facing based on the direction in degrees relative to Earth's magnetic poles in which metering device 200 is facing. In some examples, metering device 200 uses one or more other methods to determine a direction in which metering device 200 is facing based on magnetic field strength measurements generated by directional sensor 210. As will be described in more detail below, metering device 200 can further determine one or more directions in which the ground acceleration is occurring relative to metering device 200 based on the direction in which metering device 200 is facing.

In the illustrated example of FIG. 3, metering device 200 is oriented such that the x-axis along which accelerometer 208 measures ground acceleration and directional sensor 210 measures magnetic field strength aligns with the north-south direction, the y-axis along which accelerometer 208 measures ground acceleration and directional sensor 210 measures magnetic field strength aligns with the east-west direction, and the z-axis along which accelerometer 208 measures ground acceleration and directional sensor 210 measures magnetic field strength aligns with the up-down direction. Accordingly, in the illustrated example of FIG. 3, ground acceleration measurements sensed by accelerometer 208 along the x-axis correspond to ground acceleration in the north-south direction relative to metering device 200. Similarly, in the illustrated example, ground acceleration measurements sensed by accelerometer 208 along the y-axis correspond to ground acceleration in the east-west direction relative to metering device 200 and ground acceleration measurements sensed by accelerometer 208 along the z-axis correspond to ground acceleration in the up-down direction relative to metering device 200. However, persons skilled in the art will understand that FIG. 3 is just one non-limiting example of an orientation of metering device 200 installed at building and/or structure. Moreover, persons skilled in the art will understand that metering device 200 can be oriented such that the x-axis or the y-axis is aligned with directions, such as cardinal directions, ordinal directions, or other directions with respect to Earth's magnetic north, which are not shown in the illustrated example of FIG. 3.

Transceiver 212 is configured to transmit and/or receive metrology data and/or other messages to and from other devices, such as other metering devices 200, first metering device 102, second metering device 104, or computing device 106. For example, transceiver 212 transmits one or more messages that include metrology data indicative of the value of the ground acceleration proximate metering device 200 to computing device 106. As another example, transceiver 212 transmits one or more messages that include metrology data indicative of one or more directions in which the ground acceleration is occurring relative to metering device 200 to computing device 106.

Memory 214 includes one or more software applications 216 and a data store 218, coupled together. As shown, the one or more software applications 216 include earthquake detection application 220. Data store 218 stores metrology data 222 that is indicative of ground acceleration proximate metering device 200. For example, the metrology data 222 includes metrology data indicative of a value of the ground acceleration (e.g., value, amplitude value, average value, etc.) proximate metering device 200, one or more directions of the ground acceleration proximate metering device 200, one or more waveforms associated with the ground acceleration proximate metering device 200, one or more frequencies of the ground acceleration proximate metering device 200, and/or other characteristics associated with the ground acceleration proximate metering device 200. The metrology data 222 can be generated by earthquake detection application 220 which, when executed by processor 202, can perform any of the earthquake detection functionality described herein.

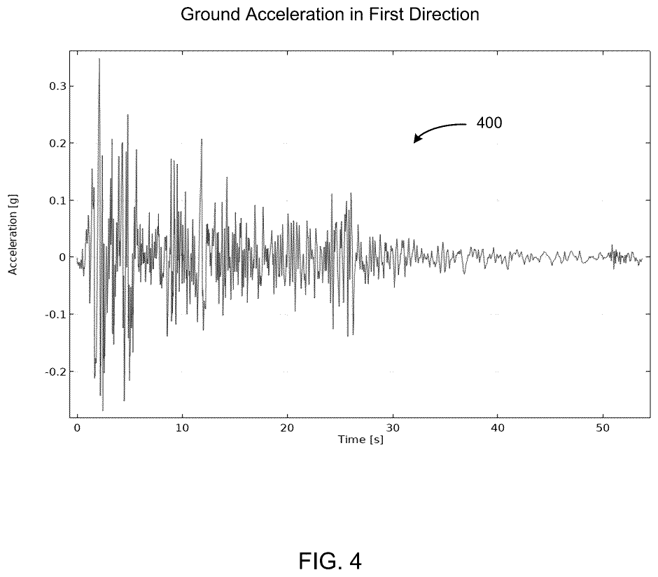

FIG. 4 illustrates a waveform associated with ground acceleration in a first direction, according to various embodiments. For example, FIG. 4 illustrates an example waveform 400 associated with ground acceleration occurring in a first direction (e.g., a north-south direction) relative to metering device 200. The waveform 400 can be generated by earthquake detection application 220 based on the ground acceleration measurements generated by accelerometer 208 and the magnetic field strength measurements generated by directional sensor 210. For example, when executed by processor 202, earthquake detection application 220 determines the ground acceleration along one or more axes (e.g., x-axis, y-axis, and z-axis) relative to metering device 200 based on ground acceleration measurements generated by accelerometer 208. Earthquake detection application 220 can further determine a direction in which metering device 200 is facing based on magnetic field strength measurements generated by directional sensor 210. Earthquake detection application 220 can then orient the measurements of ground acceleration along one or more axes relative to metering device 200 with the direction in which metering device 200 is facing. Stated another way, based on the direction in which metering device 200 is facing, earthquake detection application 220 can determine the ground acceleration proximate metering device 200 in one or more directions relative to magnetic north. Earthquake detection application 220 can then generate waveform 400 that is indicative of ground acceleration proximate metering device 200 in a first direction (e.g., north-south direction) and store waveform 400 as metrology data 222 in data store 218.

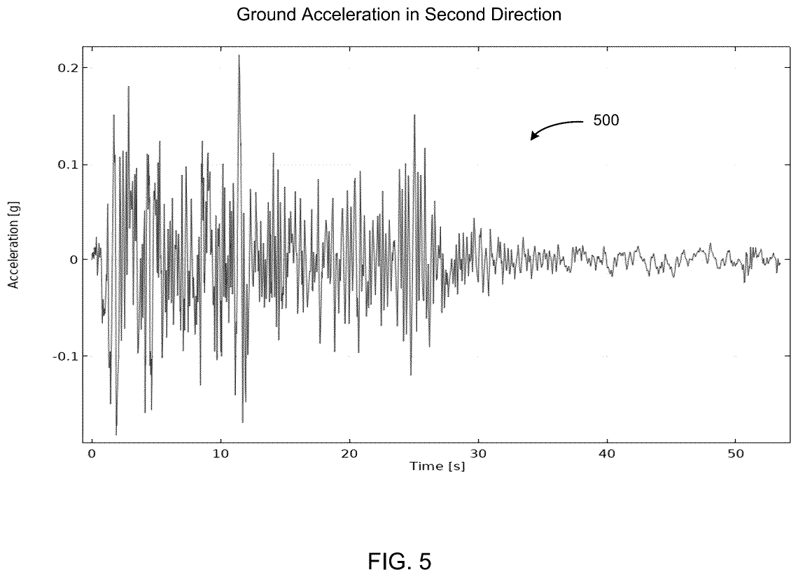

FIG. 5 illustrates a waveform associated with ground acceleration in a second direction, according to various embodiments. For example, FIG. 5 illustrates an example waveform 500 associated with ground acceleration in a second direction (e.g., an east-west direction) relative to metering device 200. As described above with respect to waveform 400, waveform 500 can be generated by earthquake detection application 220 based on the ground acceleration measurements generated by accelerometer 208 and the magnetic field strength measurements generated by directional sensor 210. Earthquake detection application 220 can further store waveform 500 as metrology data 222 in data store 218.

Data store 218 also stores one or more detection thresholds 224. Detection thresholds 224 can include one or more thresholds or other parameters associated with conditions indicative of an earthquake. In some examples, detection thresholds 224 include one or more ground acceleration thresholds associated with the occurrence of an earthquake. For example, detection thresholds 224 can include a threshold value for ground acceleration in gravitational units (g) (e.g., 0.1 (g), 0.2 (g), 0.3 (g), etc.) or some other units for measuring ground acceleration that is associated with the value and/or amplitude value of ground acceleration during an earthquake. In some examples, detection thresholds 224 include time thresholds associated with the duration of an earthquake. For example, detection thresholds 224 can include a threshold value for time in seconds (e.g., 5 seconds, 10 seconds, 30 seconds, etc.) and/or minutes (e.g., 0.1 minutes, 0.5 minutes, 1 minute, etc.) associated with the duration of an earthquake. In some examples, detection thresholds 224 include one or more thresholds associated with the frequency of ground acceleration during an earthquake. For example, detection thresholds can include a threshold range for frequency in Hertz (Hz) (e.g., 0.1 Hz, 1 Hz, 10 Hz, etc.) associated with the frequency of ground acceleration during an earthquake. In some examples, detection thresholds 224 include one or more thresholds associated with a number of ground acceleration data samples used for determining whether a condition indicative of an earthquake has been satisfied. For example, detection thresholds 224 can include a threshold value of ground acceleration data samples (e.g., 5 samples, 10 samples, 50 samples, 100 samples, etc.) that are used to determine whether a condition indicative of an earthquake has been satisfied.

In some examples, data store 218 further stores information associated with the location of metering device 200. For example, data store 218 can store information such as GPS coordinates and/or an address that identifies the location of metering device 200 and/or the location of the building or structure at which metering device 200 is installed.

When executed by processor 202, earthquake detection application 220 interfaces with one or more of accelerometer 208, directional sensor 210, transceiver 212, and data store 218 to perform any of the earthquake detection functionality described herein. For example, earthquake detection application 220 interfaces with accelerometer 208 to generate metrology data indicative of the value (e.g., value, amplitude value, average value) of ground acceleration proximate metering device 200 based on ground acceleration measurements generated by accelerometer 208. As another example, earthquake detection application 220 interfaces with directional sensor 210 to determine a direction in which metering device 200 is facing based on magnetic field strength measurements generated by directional sensor 210. Moreover, earthquake detection application 220 generates metrology data indicative of one or more directions in which ground acceleration is occurring relative to metering device 200 based on the direction in which metering device 200 is facing. For example, as described above, earthquake detection application 220 can determine and generate metrology data indicative of one or more values of ground acceleration in a first direction (e.g., north-south) relative to metering device 200, in a second direction (e.g. east-west) relative to metering device 200, in a third direction (e.g., up-down) relative to metering device 200, and/or in any other direction relative to the metering device 200 based on ground acceleration measurements generated by accelerometer 208 and magnetic field strength measurements generated by directional sensor 210.

In addition, earthquake detection application 220 interfaces with data store 218 to store metrology data generated by earthquake detection application 220 as metrology data 222. In some examples, earthquake detection application 220 also interfaces with data store 218 to use one or more detection thresholds 224 to determine whether a condition indicative of an earthquake has been satisfied. For example, earthquake detection application 220 can determine that a condition indicative of an earthquake has been satisfied if the value (e.g., value, amplitude value, average value) of ground acceleration proximate metering device 200 exceeds one or more thresholds included in detection thresholds 224, a frequency of the ground acceleration proximate metering device 200 exceeds one or more thresholds included in detection thresholds 224, a duration for which a value, amplitude value, and/or average value of the ground acceleration proximate metering device 200 exceeds one or more thresholds for a period of time included in thresholds 224, and/or a number of ground acceleration data samples for which a value, amplitude value, and/or average value of ground acceleration proximate metering device 200 exceeds one or more thresholds included in detection thresholds 224. In some examples, earthquake detection application 220 interfaces with data store 218 to filter metrology data 222 to remove noise and/or irrelevant frequencies from the ground acceleration measurements included in metrology data 222.

In some examples, earthquake detection application 220 uses a progressive detection method to detect the occurrence of an earthquake. In such examples, earthquake detection application 220 first determines whether one or more of the above-described detection thresholds 224 are satisfied based on ground acceleration measurements generated by accelerometer 208 and/or magnetic field strength measurements generated by directional sensor 210. In response to determining that one or more detection thresholds 224 are satisfied, earthquake detection application 220 begins analyzing samples of the ground acceleration measurements generated by accelerometer 208 and/or magnetic field strength measurements generated by directional sensor 210 to detect a potential earthquake. In some examples, earthquake detection application 220 performs waveform analysis to detect a potential earthquake in response to determining that one or more detection thresholds 224 are satisfied. Waveform analysis can include, for example, generating a waveform of the ground acceleration at the location at which metering device 200 is installed over time and determining a value and/or duration of the earthquake based on the waveform. Waveform analysis can also include analyzing and/or determining frequencies and/or amplitude changes in the ground acceleration at the location at which metering device 200 is installed based on the ground acceleration waveform. During the waveform analysis, earthquake detection application 220 can then determine that a condition indicative of an earthquake has been satisfied if a duration for which a value, amplitude value, and/or average value of the ground acceleration proximate metering device 200 exceeds one or more thresholds for a period of time included in thresholds 224, a duration for which a frequency of the ground acceleration proximate metering device 200 is within a particular range exceeds one or more thresholds for a period of time included in thresholds 224, and/or a number of ground acceleration data samples for which a value, amplitude value, and/or average value of ground acceleration proximate metering device 200 exceeds one or more thresholds included in detection thresholds 224.

In some examples, before the earthquake detection application 220 executing on a respective metering device 200 determines that a condition indicative of an earthquake has been satisfied, the earthquake detection application 220 executing on the respective metering device 200 further compares the metrology data generated by the respective metering device 200 to metrology data received from a second metering device 200. For example, the earthquake detection application 220 executing on the respective metering device 200 compares the metrology data generated by the respective metering device 200 and that is indicative of the values and/or directions associated with ground acceleration proximate the respective metering device 200 to metrology data received from the second metering device 200 that is indicative of the values and/or directions associated with ground acceleration proximate the second metering device 200. If the earthquake detection application 220 executing on the respective metering device 200 determines that both the metrology data generated by the respective metering device 200 and the metrology data generated by the second metering device 200 satisfies one or more conditions indicative of an earthquake, the earthquake detection application 220 determines that a condition indicative of an earthquake has been satisfied.

After determining that a condition indicative of an earthquake has been satisfied, earthquake detection application 220 interfaces with transceiver 212 to transmit one or more messages associated with an occurrence of an earthquake to one or more computing devices, such as computing device 106 or another metering device 200. For example, in response to determining that one or more conditions indicative of an earthquake have been satisfied, earthquake detection application 220 interfaces with transceiver 212 to transmit a message that indicates an earthquake has occurred to one or more computing devices. As another example, in response to determining that one or more conditions indicative of an earthquake have been satisfied, earthquake detection application 220 interfaces with transceiver 212 to transmit a message that includes metrology data indicative of an earthquake to one or more computing devices 600 and/or other metering devices 200. Metrology data indicative of an earthquake can include, for example, one or more values, directions, and/or waveforms associated with ground acceleration at the location at which metering device 200 is installed. As another example, in response to determining that one or more conditions indicative of an earthquake have been satisfied, earthquake detection application 220 interfaces with transceiver 212 to transmit a message that includes first metrology data indicative of a value of a ground acceleration proximate metering device 200 and second metrology data indicative of a direction of the ground acceleration proximate metering device 200. As another example, in response to determining that one or more conditions indicative of an earthquake have been satisfied, earthquake detection application 220 interfaces with transceiver 212 to transmit a message that includes information that identifies the location of metering device 200 to one or more computing devices.

In some examples, before a respective metering device 200 transmits a message including metrology data to a computing device, such as computing device 106, the respective metering device 200 transmits a message including metrology data to a second metering device 200 and/or receives a message including metrology data from a second metering device 200. In such examples, the respective metering device 200 transmits a message including metrology data to a computing device, such as computing device 106, when both the respective metering device 200 has determined that a condition indicative of an earthquake has been satisfied based on metrology data generated by the respective metering device 200 and when the respective metering device 200 receives messages from at least one other metering device 200 that include metrology data indicative of the occurrence of an earthquake.

### Computing Device

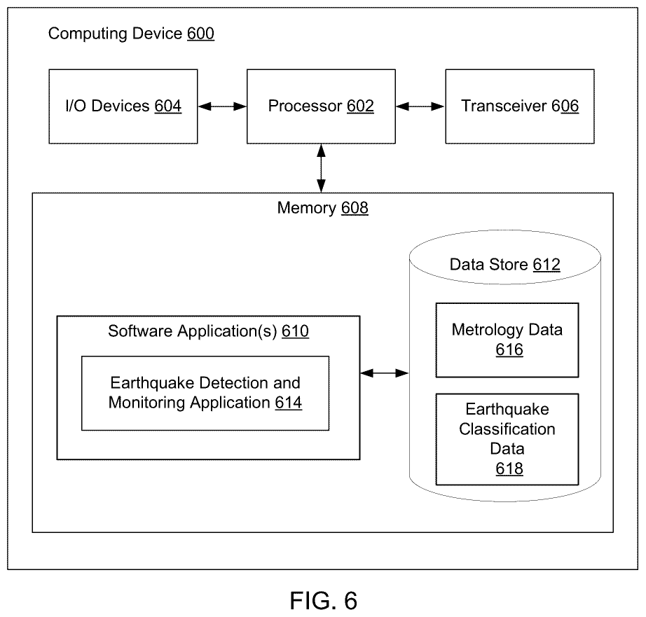

FIG. 6 illustrates computing device 600, according to various embodiments. In some embodiments, computing device 600 is used to implement computing device 106 of FIG. 1. In some embodiments computing device 600 is a computing device, such as a headend device, a backend server, or some other computing device, located at an office or other facility of a utility provider, a third party service associated with monitoring earthquake activity, and/or emergency service providers. In some embodiments, computing device 600 is used to implement first metering device 102 of FIG. 1, second metering device 104 of FIG. 1, or metering device 200 of FIG. 2. In some embodiments, computing device 600 is implemented as a streetlight that includes a network-connected controller or similar network device. As shown, computing device 600 includes, without limitation, processor 602, I/O devices 604, transceiver 606, and memory 608, coupled together.

Processor 602 coordinates operations of computing device 600. In various embodiments, processor 602 includes any hardware configured to process data and execute software applications. The processor 602 can be any technically feasible processing device configured to process data and execute program instructions. For example, processor 602 could include one or more CPUs, DSPs, GPUs, ASICS, FPGAs, microprocessors, microcontrollers, other types of processing units, and/or a combination of different processing units. Processor 602 can include an RTC (not shown) according to which processor 602 maintains an estimate of the current time. The estimate of the current time can be expressed in UTC, although any other standard of time measurement can also be used.

I/O devices 604 include devices configured to receive input, devices configured to provide output, and devices configured to both receive input and provide output. Transceiver 606 is configured to transmit messages and/or receive metrology data and/or other messages from devices, such as first metering device 102, second metering device 104, metering devices 200, and/or other devices associated with utility service providers, a third party service associated with monitoring earthquake activity, and/or emergency service providers.

Memory 608 includes one or more software applications 610 and a data store 612, coupled together. As shown, the one or more software applications 610 include earthquake classification application 614. Data store 612 stores metrology data 616 and earthquake classification data 618. Metrology data 616 includes, for example, metrology data indicative of ground acceleration that is received from one or more metering devices 200. For example, metrology data 616 includes metrology data indicative of one or more values (e.g., value, amplitude value, average value) of the ground acceleration proximate various metering devices 200, one or more directions associated with the ground acceleration proximate various metering devices 200, one or more waveforms associated with the ground acceleration proximate various metering devices 200, one or more frequencies of the ground acceleration proximate various metering devices 200, one or more locations associated with various metering devices 200, and/or other characteristics associated with ground acceleration proximate various metering devices 200. In some examples, metrology data 616 includes one or more ground acceleration waveforms similar to waveform 400 and/or waveform 500.

Data store 612 also stores earthquake classification data 618. In some examples, earthquake classification data 618 can include one or more equations and/or algorithms that are used for classifying and/or determining a characteristic of an earthquake. In some examples, earthquake classification data 618 can include one or more scales and/or templates that are used for classifying and/or determining a characteristic of an earthquake. For example, earthquake classification data 618 can include data indicative of the Richter scale that is used for determining a magnitude of an earthquake. As another example, earthquake classification data 618 can include data indicative of the modified Mercalli scale and/or the Rossi-Forel scale used for determining an intensity of an earthquake.

In some examples, earthquake classification data 618 can include ground acceleration data and one or more characteristics associated with earthquakes that have previously occurred. As an example, earthquake classification data 618 can include a plurality of earthquake classification data samples. In this example, each earthquake classification data sample includes ground acceleration data associated with an earthquake that previously occurred and one or more classifications, or characteristics, of the earthquake that previously occurred. For example, each earthquake classification data sample further includes a magnitude and/or an intensity of the earthquake that previously occurred. In some examples, each earthquake classification data sample includes one or more ground acceleration waveforms associated with the earthquake that previously occurred. For example, each earthquake classification data sample can include a waveform indicative of ground acceleration in a first direction (e.g., north-south) during the earthquake that previously occurred, a waveform indicative of ground acceleration in a second direction (e.g., east-west) during the earthquake that previously occurred, and one or more other waveforms indicative of ground acceleration in one or more other directions during the earthquake that previously occurred. In some examples, each earthquake classification data sample further includes information indicative of a duration of the earthquake that previously occurred and/or one or more locations associated with the earthquake that previously occurred.

When executed by processor 602, earthquake classification application 614 can perform any of the earthquake determination and/or classification functionality described herein. For example, earthquake classification application 614 interfaces with transceiver 606 to receive messages that include metrology data indicative of the ground acceleration proximate one or metering devices 200. As another example, earthquake classification application 614 interfaces with transceiver 606 to transmit one or more messages associated with the occurrence of an earthquake to one or more computing devices associated with utility service providers, a third-party service associated with monitoring earthquake activity, and/or emergency service providers. For example, the one or more messages indicate one or more locations that have been subjected to a high intensity during the earthquake where destruction of infrastructure, loss of supply of utility commodities, and/or human casualty are likely to be higher.

In addition, earthquake classification application 614 interfaces with data store 612 to store metrology data indicative of ground acceleration received from one or more metering devices 200. Earthquake classification application 614 also interfaces with data store 612 to determine, based on the metrology data indicative of ground acceleration received from one or more metering devices 200, one or more characteristics of an earthquake that has occurred. In some examples, earthquake classification application 614 uses one or more formulas and/or algorithms stored in data store 612 to determine a magnitude and/or an intensity of an earthquake based on the metrology data indicative of ground acceleration received from one or more metering devices 200. In some examples, earthquake classification application 614 uses data indicative of the Richter scale to determine a magnitude of an earthquake that has occurred based on the metrology indicative of ground acceleration received from one or more metering devices 200. In some examples, earthquake classification application 614 uses data indicative of the modified Mercalli scale and/or the Rossi-Forel scale to determine an intensity of an earthquake that has occurred based on the metrology data indicative ground acceleration received from one or more metering devices 200.

In some examples, earthquake classification application 614 determines one or more characteristics of an earthquake that has occurred by comparing the metrology data indicative of ground acceleration received from one or more metering devices 200 to earthquake classification data 618 stored in data store 612. For example, earthquake classification application 614 can identify earthquake classification data samples included in earthquake classification data 618 that include ground acceleration data and/or ground acceleration waveforms that are similar to the metrology data indicative of ground acceleration received from one or more metering devices 200. When earthquake classification application 614 identifies an earthquake classification data sample that is similar to the metrology indicative of ground acceleration received from one or more metering devices 200, earthquake classification application 614 determines that the magnitude and/or intensity of an earthquake that has occurred is approximately equal to the magnitude and/or intensity included in the similar earthquake classification data sample. For example, if an earthquake classification data sample indicates that the magnitude of an earthquake that previously occurred was a 5.5 on the Richter scale, earthquake classification application 614 can determine that an earthquake that occurred has a magnitude of approximately 5.5 on the Richter scale when metrology data indicative of ground acceleration received from one or more metering devices 200 is similar to the ground acceleration data included in the earthquake classification data sample.

In some examples, earthquake classification application 614 determines one or more directions associated with ground acceleration caused by an earthquake based on metrology data indicative of ground acceleration and/or location information received from one or more metering devices 200. For example, earthquake classification application 614 can determine values of ground acceleration along one or more directions (e.g., north-south, east-west, up-down, etc.) relative to computing device 600 based metrology data received from one or more metering devices 200.

In some examples, earthquake classification application 614 determines a location associated with an earthquake that has occurred based on metrology data indicative of ground acceleration and/or location information received from one or more metering devices 200. For example, earthquake classification application 614 receives a first message from a first metering device 200 that identifies a first location (e.g., GPS coordinates, address, etc.) at which metrology data indicative of a value of and/or one or more directions associated with ground acceleration at the first location was generated. Further, in this example, earthquake classification application 614 receives a second message from a different metering device 200 that identifies a different location (e.g., GPS coordinates, address, etc.) at which metrology data indicative of a value of and/or one or more directions associated with ground acceleration at the different location was generated. Based on the location information included in these first and second messages, earthquake classification application 614 can determine one or more of a location of the hypocenter of the earthquake that has occurred, a location of the epicenter of the earthquake that has occurred, and/or one or more locations that have been subjected to a high intensity during the earthquake where destruction of infrastructure, loss of supply of utility commodities, and/or human casualty are likely to be higher.

In some examples, earthquake classification application 614 performs one or more actions in response to determining one or more characteristics associated with the earthquake. In some examples, in response to determining a location that has been subjected to a high intensity motion during the earthquake where destruction of infrastructure, loss of supply of utility commodities, and/or human casualty are likely to be higher, earthquake classification application 614 transmits one or more messages identifying the location to one or more computing devices associated with emergency service providers (e.g., police station, fire station, etc.) and/or utility providers. In some examples, earthquake classification application 614 can shut off the supply of one or more utility commodities at a location in response to determining that the location has been subjected to a high intensity during the earthquake. In some examples, earthquake classification application 614 can monitor the health of infrastructure, such as buildings and/or other structures, based on metrology data received from metering devices 200.

### Detecting an Earthquake

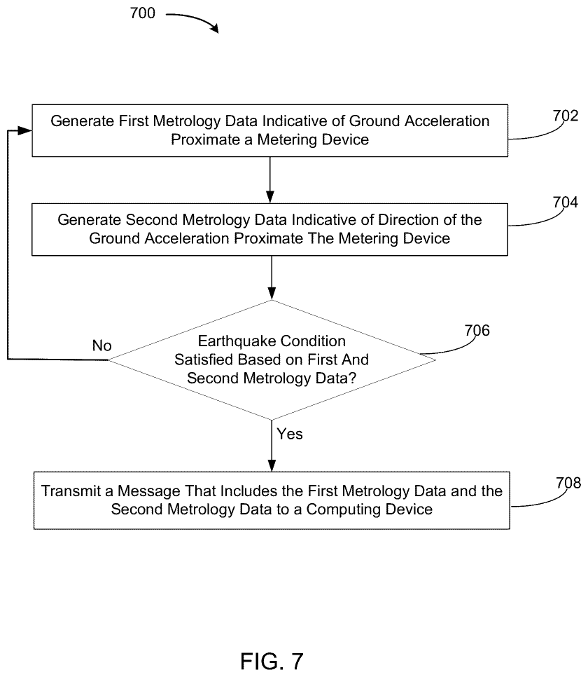

FIG. 7 is a flow diagram of method steps for detecting an earthquake, according to various embodiments. Although the method steps of FIG. 7 are described as being performed by metering device 200 using earthquake detection application 220, the method steps of FIG. 7 can also be performed, for example, by first metering device 102, second metering device 104, or some other suitable communication device, such as a streetlight that includes a network-connected controller, that includes an accelerometer and a directional sensor as described above with respect to FIGS. 1-6. Furthermore, although the method steps are shown in an order, persons skilled in the art will understand that some method steps may be performed in a different order, repeated, and/or performed by components other than those described in FIG. 7.

As shown, a method 700 begins at step 702, where earthquake detection application 220 generates first metrology data indicative of a value of the ground acceleration proximate metering device 200. For example, accelerometer 208 generates one or more measurements indicative the value of the ground acceleration proximate metering device 200 and earthquake detection application 220 generates, based on the one or more measurements generated by accelerometer 208, first metrology data indicative of the value of the ground acceleration proximate metering device 200. The first metrology data can include one or more values of the ground acceleration proximate metering device 200, one or more amplitude values of the ground acceleration proximate metering device 200, an average value of the ground acceleration proximate metering device 200, one or more frequencies of the ground acceleration proximate metering device 200, one or more waveforms of the ground acceleration proximate metering device 200, a duration for which the value the ground acceleration proximate metering device 200 exceeds a threshold, and/or a duration for which the value frequency of the ground acceleration proximate metering device 200 is within a certain frequency range.

At step 704, earthquake detection application 220 generates second metrology data indicative of one or more directions of the ground acceleration proximate metering device 200. For example, directional sensor 210 generates one or more measurements indicative of the magnetic field strength proximate metering device 200. Based on magnetic field strength measurements generated by directional sensor 210, earthquake detection application 220 can determine a direction (e.g., north, south, east, west, northwest, northeast, southwest, or southeast) in which metering device 200 is facing. Earthquake detection application 220 can further determine, based on the direction in which metering device 200 is facing, one or more directions in which the ground acceleration proximate is occurring relative to metering device 200. The second metrology data can include, for example, ground acceleration in a first direction (e.g., north-south direction) relative to metering device 200 and ground acceleration in a second direction (e.g., east-west direction) relative to metering device 200. In some examples, the second metrology data further includes information that identifies a location of metering device 200, such as GPS coordinates and/or an address of a building or structure at which metering device 200 is installed.

At step 706, earthquake detection application 220 determines whether one or more conditions indicative of an earthquake have been satisfied based on the first metrology data. As described herein, in some examples, earthquake detection application 220 determines that a condition indicative of an earthquake has been satisfied when a value of the ground acceleration proximate metering device 200 exceeds a threshold (e.g., 0.1 (g), 0.2 (g), 0.3 (g), etc.) included in detection thresholds 224. In some examples, earthquake detection application 220 determines that a condition indicative of an earthquake has been satisfied when an amplitude value of the ground acceleration proximate metering device 200 exceeds a threshold (e.g., 0.1 (g), 0.2 (g), 0.3 (g), etc.) included in detection thresholds 224. In some examples, earthquake detection application 220 determines that a condition indicative of an earthquake has been satisfied when an average value of the ground acceleration proximate metering device 200 exceeds a threshold (e.g., 0.1 (g), 0.2 (g), 0.3 (g), etc.) included in detection thresholds 224. In some examples, earthquake detection application 220 determines that a condition indicative of an earthquake has been satisfied when a frequency of the ground acceleration proximate metering device 200 is within a certain frequency range (e.g., between 0.1 Hz and 10 Hz) included in detection thresholds 224. In some examples, earthquake detection application 220 determines that an average of the ground acceleration values included in a plurality of data samples (e.g., 5 sample, 10 samples, 50 samples, 100 samples, etc.) generated by the accelerometer exceeds a threshold (e.g., 0.1 (g), 0.2 (g), 0.3 (g), etc.) included in detection thresholds 224. In some examples, earthquake detection application 220 determines that a condition indicative of an earthquake has been satisfied when a value of the ground acceleration proximate metering device 200 exceeds a threshold (e.g., 0.1 (g), 0.2 (g), 0.3 (g), etc.) included in detection thresholds 224 for a particular duration (e.g., 5 seconds, 30 seconds, 1 minute, etc.). In some examples, earthquake detection application 220 determines that a condition indicative of an earthquake has been satisfied when a frequency of the ground acceleration proximate metering device 200 is within a certain threshold (e.g., between 0.1 Hz and 10 Hz) included in detection thresholds 224 for a particular duration (e.g., 5 seconds, 30 seconds, 1 minute, etc.).

In other examples, at step 706, earthquake detection application 220 uses a progressive detection method to determine whether one or more conditions indicative of an earthquake have been satisfied based on the first metrology data and/or the second metrology data. In such examples, earthquake detection application 220 first determines whether ground acceleration measurements generated by accelerometer 208 satisfy one or more of above-described detection thresholds 224. Then, in response to determining that one or more detection thresholds 224 are satisfied, earthquake detection application 220 begins analyzing samples of the ground acceleration measurements generated by accelerometer 208 to determine whether a condition indicative of an earthquake is satisfied. For example, earthquake detection application 220 performs waveform analysis on the ground acceleration measurements generated by accelerometer 208 to detect a potential earthquake in response to determining that one or more detection thresholds 224 are satisfied. During the waveform analysis, earthquake detection application 220 can determine that a condition indicative of an earthquake has been satisfied when a duration for which a value, amplitude value, and/or average value of the ground acceleration proximate metering device 200 exceeds one or more thresholds for a period of time included in thresholds 224, a duration for which a frequency of the ground acceleration proximate metering device 200 is within a particular range exceeds one or more thresholds for a period of time included in thresholds 224, and/or a number of ground acceleration data samples for which a value, amplitude value, and/or average value of ground acceleration proximate metering device 200 exceeds one or more thresholds included in detection thresholds 224.

If, at step 706, earthquake detection application 220 determines that one or more conditions indicative of an earthquake have been satisfied, method 700 proceeds to step 708. However, if earthquake detection application 220 determines that one or more conditions indicative of an earthquake have not been satisfied, method 700 returns to step 702 where earthquake detection application 220 generates additional first metrology data indicative of the value of the ground acceleration proximate metering device 200.

At step 708, earthquake detection application 220 transmits one or more messages that include the first metrology data and/or second metrology data to computing device 600 and/or another metering device 200. In some examples, the one or more messages further include a notification and/or indication that an earthquake has occurred. In some examples, the one or more messages further include information that identifies the location of metering device 200, such as GPS coordinates and/or an address of a building or structure at which metering device 200 is installed.

### Determining a Characteristic of an Earthquake

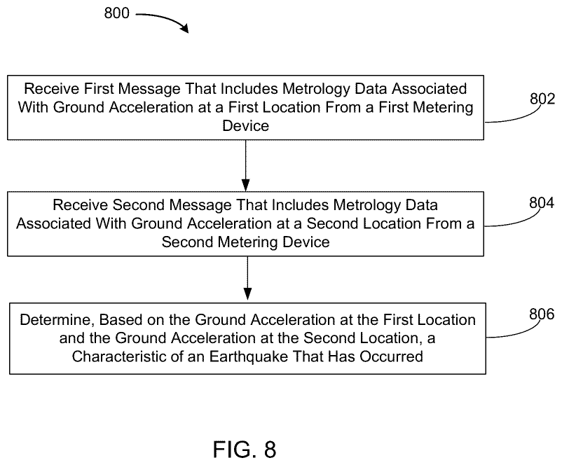

FIG. 8 is a flow diagram of method steps for determining a characteristic of an earthquake, according to various embodiments. Although the method steps of FIG. 8 are described as being performed by computing device 600 using earthquake classification application 614, the method steps of FIG. 8 can also be performed, for example, by computing device 106 or some other suitable computing device that can receive metrology data from metering devices as described above with respect to FIGS. 1-6. In some examples, the method steps of FIG. 8 can be performed by a metering device, such as first metering device 102, second metering device 104, or metering device 200, or by some other suitable communication device, such as a streetlight that includes a network-enabled controller, that includes an accelerometer and a directional sensor as described above with respect to FIGS. 1-6. Furthermore, although the method steps are shown in an order, persons skilled in the art will understand that some method steps may be performed in a different order, repeated, and/or performed by components other than those described in FIG. 8.

As shown, a method 800 begins at step 802, where earthquake classification application 614 receives a first message that includes metrology data associated with the ground acceleration at a first location from a first metering device 200. The metrology data associated with the ground acceleration at the first location includes, for example, one or more values of the ground acceleration at the first location, one or more amplitude values of the ground acceleration at the first location, an average value of the ground acceleration at the first location, one or more frequencies of the ground acceleration at the first location, the value of the ground acceleration in one or more directions relative to the first location, one or more waveforms of the ground acceleration at the first location, a duration for which the value of the ground acceleration at the first location exceeds a threshold, and/or a duration for which the frequency of the ground acceleration at the first location is within a certain frequency range. In some examples, the first message further includes a notification and/or an indication that an earthquake has occurred. In some examples, the first message further includes information, such as GPS coordinates and/or an address, which identifies the first location.

At step 804, earthquake classification application 614 receives a second message that includes metrology data associated with the ground acceleration at a second location from a second metering device 200. The metrology data associated with the ground acceleration at the second location includes, for example, one or more values of the ground acceleration at the second location, one or more amplitude values of the ground acceleration at the second location, an average value of the ground acceleration at the second location, one or more frequencies of the ground acceleration at the second location, the value of the ground acceleration in one or more directions relative to the second location, one or more waveforms of the ground acceleration at the second location, a duration for which the value of the ground acceleration at the second location exceeds a threshold, and/or a duration for which the frequency of the ground acceleration at the second location is within a certain frequency range. In some examples, the second message further includes a notification and/or an indication that an earthquake has occurred. In some examples, second message further includes information, such as GPS coordinates and/or an address, that identifies the second location.

At step 806, earthquake classification application 614 determines one or more characteristics of an earthquake that has occurred based on the ground acceleration at the first location and the ground acceleration at the second location. For example, earthquake classification application 614 determines one or more of a magnitude of an earthquake that has occurred, an intensity of an earthquake that has occurred, a direction associated with the ground acceleration caused by an earthquake, and/or a location associated with an earthquake that has occurred based on the ground acceleration at the first location and the ground acceleration at the second location.

In some examples, earthquake classification application 614 uses the Richter scale to determine the magnitude of an earthquake that has occurred based on the ground acceleration at the first location and the ground acceleration at the second location. In some examples, earthquake classification application 614 uses the modified Mercalli scale or Rossi-Forel scale to determine the intensity of an earthquake that has occurred based on the ground acceleration at the first location and the ground acceleration at the second location. In some examples, earthquake classification application 614 uses one or more formulas and/or algorithms to determine a magnitude and/or an intensity of an earthquake that has occurred based on the ground acceleration at the first location and the ground acceleration at the second location.

In some examples, earthquake classification application 614 uses pattern cognition to determine a magnitude and/or an intensity of an earthquake based on the ground acceleration at the first location and the ground acceleration at the second location. For example, earthquake classification application 614 can identify an earthquake classification data sample included in earthquake classification data 618 that includes ground acceleration data and/or ground acceleration waveforms that are similar to the ground acceleration at the first location and the ground acceleration at the second location. When earthquake classification application 614 identifies an earthquake classification data sample that is similar to the ground acceleration at the first location and the ground acceleration at the second location, earthquake classification application 614 can determine that the magnitude and/or intensity of an earthquake that has occurred is approximately equal to the magnitude and/or intensity included in the earthquake classification data sample. For example, if an earthquake classification data sample indicates that the magnitude of an earthquake that previously occurred was a 5.5 on the Richter scale, earthquake classification application 614 can determine that an earthquake that occurred has a magnitude of approximately 5.5 on the Richter scale when the ground acceleration at the first location and the ground acceleration at the second location are similar to the earthquake classification data sample included in earthquake classification data 618.

In some examples, earthquake classification application 614 determines a location associated with an earthquake that has occurred based on location information included in the first and second messages. For example, the first message includes information that identifies the first location (e.g., GPS coordinates, address, etc.) and metrology data that indicates one or more directions in which the ground acceleration occurs relative to the first location. Further, in this example, the second message includes information that identifies the second location (e.g., GPS coordinates, address, etc.) and metrology data that indicates one or more directions in which the ground acceleration occurs relative to the second location. Based on this location information included in the first and second messages, earthquake classification application 614 can determine one or more of a location of the hypocenter of an earthquake that has occurred, a location of the epicenter of an earthquake that has occurred, and/or a location that has been subjected to a high intensity during the earthquake where destruction of infrastructure, loss of supply of utility commodities, and/or human casualty are likely to be higher.

In some examples, earthquake classification application 614 further performs one or more actions in response to determining one or more characteristics associated with an earthquake that has occurred. For example, in response to determining location that has been subjected to a high intensity during the earthquake where destruction of infrastructure, loss of supply of utility commodities, and/or human casualty are likely to be higher, earthquake classification application 614 transmits one or more messages identifying the location to one or more computing devices associated with emergency service providers (e.g., fire station, police station, etc.) and/or utility providers.

### System Overview

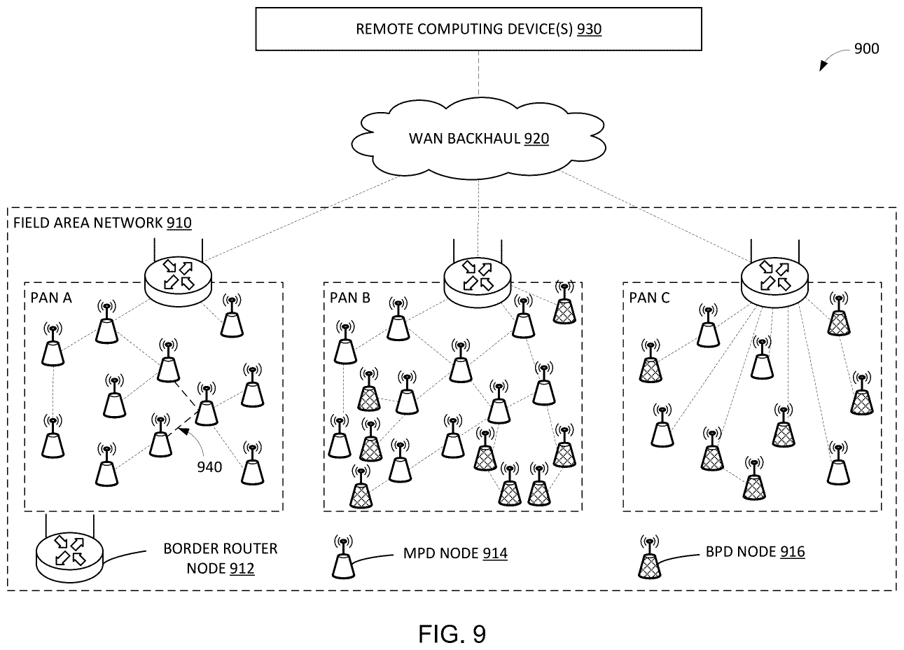

FIG. 9 illustrates a network system configured to implement one or more aspects of the various embodiments. As shown, network system 900 includes a field area network (FAN) 910, a wide area network (WAN) backhaul 920, and one or more remote computing devices 930. FAN 910 is coupled to remote computing device(s) 930 via WAN backhaul 920.

FAN 910 includes personal area network (PANs) A, B, and C. PANs A and B are organized according to a mesh network topology, while PAN C is organized according to a star network topology. Each of PANs A, B, and C includes various network devices including at least one border router node 912 and one or more mains-powered device (MPD) nodes 914. PANs B and C further include one or more battery-powered device (BPD) nodes 916. Any of the one or more MPD nodes 914 or the BPD nodes 916 can be used to implement the techniques discussed above with respect to FIGS. 1-8. In various embodiments, nodes 914 or 916 can be implemented as first metering device 102, second metering device 104, metering device 200, computing device 106, and/or computing device 600. In some embodiments, nodes 914 or 916 can be implemented as some other suitable communication devices, such as streetlights, which include an accelerometer and a directional sensor as described above with respect to FIGS. 1-6.

MPD nodes 914 draw power from an external power source, such as mains electricity or a power grid. MPD nodes 914 typically operate on a continuous basis without powering down for extended periods of time. BPD nodes 916 draw power from an internal power source, such as a battery. BPD nodes 916 typically operate intermittently and power down, go to very low power mode, for extended periods of time in order to conserve battery power.

MPD nodes 914 and BPD nodes 916 are coupled to, or included within, a utility distribution infrastructure (not shown) that distributes a resource to consumers. MPD nodes 914 and BPD nodes 916 gather sensor data related to the distribution of the resource, process the sensor data, and communicate processing results and other information to remote computing device(s) 930. Border router nodes 912 operate as access points to provide MPD nodes 914 and BPD nodes 916 with access to remote computing device(s) 930.

Any of border router nodes 912, MPD nodes 914, and BPD nodes 916 are configured to communicate directly with one or more adjacent nodes via bi-directional communication links 940. The communication links 940 may be wired or wireless links, although in practice, adjacent nodes of a given PAN exchange data with one another by transmitting data packets via wireless radio frequency (RF) communications. The various node types are configured to perform a technique known in the art as “channel hopping” in order to periodically receive data packets on varying channels. As known in the art, a “channel” may correspond to a particular range of frequencies. In one embodiment, a node may compute a current receive channel by evaluating a Jenkins hash function based on a total number of channels and the media access control (MAC) address of the node.

In some examples, MPD nodes 914 or BPD nodes 916 can communicate directly with remote computing devices 930 via respective cellular communication links. In such examples, MPD nodes 914 or BPD nodes 916 can transmit messages to and/or receive messages from remote computing devices 930 without using border router nodes 912. Furthermore, in some examples, remote computing devices 930 are implemented as MPD nodes 914 or BPD nodes 916. In such examples, MPD nodes 914 and BPD nodes 916 can perform the control and/or data analysis functions described herein with respect to remote computing devices 930.

In some examples, each node within a given PAN can implement a discovery protocol to identify one or more adjacent nodes or “neighbors.” A node that has identified an adjacent, neighboring node can establish a bi-directional communication link 940 with the neighboring node. Each neighboring node may update a respective neighbor table to include information concerning the other node, including one or more of the MAC address of the other node, listening schedule information for the other node, a received signal strength indication (RSSI) of the communication link 940 established with that node, and the like.

Nodes can compute the channel hopping sequences of adjacent nodes to facilitate the successful transmission of data packets to those nodes. In embodiments where nodes implement the Jenkins hash function, a node computes a current receive channel of an adjacent node using the total number of channels, the MAC address of the adjacent node, and a time slot number assigned to a current time slot of the adjacent node.

Any of the nodes discussed above may operate as a source node, an intermediate node, or a destination node for the transmission of data packets. A given source node can generate a data packet and then transmit the data packet to a destination node via any number of intermediate nodes (in mesh network topologies). The data packet can indicate a destination for the packet and/or a particular sequence of intermediate nodes to traverse in order to reach the destination node. In one embodiment, each intermediate node can include a forwarding database indicating various network routes and cost metrics associated with each route.

Nodes can transmit messages and/or data packets across a given PAN and across WAN backhaul 920 to remote computing device(s) 930. Similarly, remote computing device(s) 930 can transmit messages and/or data packets across WAN backhaul 920 and across any given PAN to a particular node included therein. As a general matter, numerous routes can exist which traverse any of PANs A, B, and C and include any number of intermediate nodes, thereby allowing any given node or other component within network system 900 to communicate with any other node or component included therein.

Remote computing device(s) 930 includes one or more server machines (not shown) or other computing devices configured to operate as sources for, or destinations of, messages and/or data packets that traverse within network system 900. The server machines can query nodes within network system 900 to obtain various data, including raw or processed sensor data, power consumption data, node/network throughput data, status information, and so forth. The server machines can also transmit commands and/or program instructions to any node within network system 900 to cause those nodes to perform various operations. In one embodiment, each server machine is a computing device configured to execute, via a processor, a software application stored in a memory to perform various network management and/or earthquake classification operations. In various embodiments, computing device 106 and computing device 600 are implemented as remote computing device(s) 930.

1. In various embodiments, a method comprises generating, by a metering device, first metrology data indicative of a value of a ground acceleration proximate the metering device; generating, by the metering device, second metrology data indicative of a direction of the ground acceleration proximate the metering device; determining, by the metering device based on the first metrology data, that a condition indicative of an earthquake has been satisfied; and in response to determining that the condition indicative of the earthquake has been satisfied, transmitting, by the metering device, a message that includes the first metrology data and the second metrology data to a computing device.

2. The method of clause 1, wherein determining that the condition indicative of the earthquake has been satisfied comprises at least one of: determining that the value of the ground acceleration proximate the metering device exceeds a threshold; determining that a frequency of the ground acceleration proximate the metering device is within a certain frequency range; or determining that the value of the ground acceleration proximate the metering device has exceeded the threshold for a particular amount of time.

3. The method of clause 1 or 2, wherein the computing device is a second metering device.

4. The method of any one of clauses 1-3, wherein generating the first metrology data comprises: generating, by an accelerometer, a first measurement indicative of a first value of the ground acceleration along a first axis relative to the metering device; generating, by the accelerometer, a second measurement indicative of a second value of the ground acceleration along a second axis relative to the metering device; and generating, by the accelerometer, a third measurement indicative of a third value of the ground acceleration along a third axis relative to the metering device.

5. The method of any one of clauses 1-4, wherein generating the second metrology data includes: generating, by a sensor, a measurement indicative of a strength of a magnetic field proximate the metering device; determining, by the metering device based on the strength of the magnetic field proximate the metering device, a direction in which the metering device is facing; and determining, by the metering device based on the direction in which the metering device is facing, the direction of the ground acceleration relative to the metering device.

6. The method of any one of clauses 1-5, wherein determining the direction of the ground acceleration relative to the metering device comprises: determining a first value of the ground acceleration proximate the metering device in a first direction relative to the metering device; determining a second value of the ground acceleration proximate the metering device in a second direction relative to the metering device; and determining a third value of the ground acceleration proximate the metering device in a third direction relative to the metering device.

7. The method of any one of clauses 1-6, wherein the sensor is a three-axis accelerometer.

8. The method of any one of clauses 1-7, wherein the message includes information that identifies a location of the metering device.

9. One or more non-transitory machine-readable media comprising a plurality of machine-readable instructions which when executed by one or more processors associated with a computer-assisted system are adapted to cause the one or more processors to perform the method of any one of clauses 1-8.

10. In various embodiments, a network device comprises an accelerometer configured to sense a ground acceleration proximate the network device; a magnetometer configured to sense a strength of a magnetic field proximate the network device; one or more processors; and a memory storing executable instructions that, when executed by the one or more processors, cause the one or more processors to: generate first metrology data based on the ground acceleration sensed by the accelerometer; generate second metrology data based on a magnetic field strength sensed by the magnetometer; determine that a condition indicative of an earthquake has been satisfied based on the ground acceleration sensed by the accelerometer; and in response to determining that the condition indicative of the earthquake has been satisfied, transmit a message that indicates that an earthquake has occurred to a server.

11. The network device of clause 10, wherein the network device is a metering device that further comprises metering circuitry configured to monitor consumption of a utility commodity that includes at least one of electricity, gas, heat, or water.

12. The network device of clause 10 or 11, wherein the network device is a controller included in a streetlight.

13. The network device of any one of clauses 10-12, wherein the message includes at least one of the first metrology data, the second metrology data, or information that identifies a location at which the network device is installed.

14. The network device of any one of clauses 10-13, wherein the first metrology data includes at least one of an amplitude of the ground acceleration proximate the network device or a waveform of the ground acceleration proximate the network device.

15. The network device of any one of clauses 10-14, wherein the second metrology data includes a direction in which the ground acceleration is occurring relative to the network device.

16. In various embodiments, a method comprises: receiving, by a computing device, a first message that includes metrology data associated with ground acceleration at a first location from a first metering device; receiving, by the computing device, a second message that includes metrology data associated with ground acceleration at a second location from a second metering device; and determining, based at least on the ground acceleration at the first location and the ground acceleration at the second location, a characteristic of an earthquake.

17. The method of clause 16, wherein determining the characteristic of the earthquake includes determining at least one of a magnitude or an intensity of the earthquake.

18. The method of clause 16 or 17, wherein determining the characteristic of the earthquake includes determining at least one of a location that has been subjected to a high intensity during the earthquake or a direction associated with ground acceleration caused by the earthquake.

19. The method of any one of clauses 16-18, wherein determining the characteristic of the earthquake includes: determining that the ground acceleration at the first location and the ground acceleration at the second location are similar to ground acceleration data associated with a second earthquake that previously occurred; and determining that a magnitude of the earthquake is approximately equal to the magnitude of the second earthquake that previously occurred.

20. One or more non-transitory machine-readable media comprising a plurality of machine-readable instructions which when executed by one or more processors associated with a computer-assisted system are adapted to cause the one or more processors to perform the method of any one of clauses 16-19.

Any and all combinations of any of the claim elements recited in any of the claims and/or any elements described in this application, in any fashion, fall within the contemplated scope of the present protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments can be embodied as a system, method or computer program product. Accordingly, aspects of the present disclosure can take the form of an entirely hardware embodiment, an entirely software embodiment (including firmware, resident software, micro-code, etc.) or an embodiment combining software and hardware aspects that can all generally be referred to herein as a “module,” a “system,” or a “computer.” In addition, any hardware and/or software technique, process, function, component, engine, module, or system described in the present disclosure can be implemented as a circuit or set of circuits. Furthermore, aspects of the present disclosure can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors can be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure can be devised without departing from the basic scope thereof, and the scope thereof is determined by the claims that follow. Moreover, in the above description, numerous specific details are set forth to provide a more thorough understanding of the various embodiments. However, it will be apparent to one of skill in the art that the inventive concepts may be practiced without one or more of these specific details.

What is claimed is:

1. A method comprising:
generating, by a metering device, first metrology data indicative of a value of a ground acceleration proximate the metering device;
generating, by the metering device, second metrology data indicative of a direction of the ground acceleration proximate the metering device;
determining, by the metering device based on the first metrology data, that a condition indicative of an earthquake has been satisfied; and
in response to determining that the condition indicative of the earthquake has been satisfied, transmitting, by the metering device, a message that includes the first metrology data and the second metrology data to a computing device.

2. The method of claim 1, wherein determining that the condition indicative of the earthquake has been satisfied comprises at least one of:
determining that the value of the ground acceleration proximate the metering device exceeds a threshold;
determining that a frequency of the ground acceleration proximate the metering device is within a certain frequency range; or
determining that the value of the ground acceleration proximate the metering device has exceeded the threshold for a particular amount of time.

3. The method of claim 1, wherein the computing device is a second metering device.

4. The method of claim 1, wherein generating the first metrology data comprises:
generating, by an accelerometer, a first measurement indicative of a first value of the ground acceleration along a first axis relative to the metering device;
generating, by the accelerometer, a second measurement indicative of a second value of the ground acceleration along a second axis relative to the metering device; and
generating, by the accelerometer, a third measurement indicative of a third value of the ground acceleration along a third axis relative to the metering device.

5. The method of claim 1, wherein generating the second metrology data includes:
generating, by a sensor, a measurement indicative of a strength of a magnetic field proximate the metering device;
determining, by the metering device based on the strength of the magnetic field proximate the metering device, a direction in which the metering device is facing; and
determining, by the metering device based on the direction in which the metering device is facing, the direction of the ground acceleration relative to the metering device.

6. The method of claim 5, wherein determining the direction of the ground acceleration relative to the metering device comprises:
determining a first value of the ground acceleration proximate the metering device in a first direction relative to the metering device;
determining a second value of the ground acceleration proximate the metering device in a second direction relative to the metering device; and
determining a third value of the ground acceleration proximate the metering device in a third direction relative to the metering device.

7. The method of claim 5, wherein the sensor is a three-axis accelerometer.

8. The method of claim 1, wherein the message includes information that identifies a location of the metering device.

9. One or more non-transitory machine-readable media comprising a plurality of machine-readable instructions which when executed by one or more processors associated with a computer-assisted system are adapted to cause the one or more processors to perform the method of claim 1.

10. A network device comprising:
an accelerometer configured to sense a ground acceleration proximate the network device;
a magnetometer configured to sense a strength of a magnetic field proximate the network device;
one or more processors; and
a memory storing executable instructions that, when executed by the one or more processors, cause the one or more processors to:
generate first metrology data based on the ground acceleration sensed by the accelerometer;
generate second metrology data based on a magnetic field strength sensed by the magnetometer;
determine that a condition indicative of an earthquake has been satisfied based on the ground acceleration sensed by the accelerometer; and
in response to determining that the condition indicative of the earthquake has been satisfied, transmit a message that indicates that an earthquake has occurred to a server.

11. The network device of claim 10, wherein the network device is a metering device that further comprises metering circuitry configured to monitor consumption of a utility commodity that includes at least one of electricity, gas, heat, or water.

12. The network device of claim 10, wherein the network device is a controller included in a streetlight.

13. The network device of claim 10, wherein the message includes at least one of the first metrology data, the second metrology data, or information that identifies a location at which the network device is installed.

14. The network device of claim 10, wherein the first metrology data includes at least one of an amplitude of the ground acceleration proximate the network device or a waveform of the ground acceleration proximate the network device.

15. The network device of claim 10, wherein the second metrology data includes a direction in which the ground acceleration is occurring relative to the network device.

16. A method comprising:
receiving, by a computing device, a first message that includes metrology data associated with ground acceleration at a first location from a first metering device;
receiving, by the computing device, a second message that includes metrology data associated with ground acceleration at a second location from a second metering device; and
determining, based at least on the ground acceleration at the first location and the ground acceleration at the second location, a characteristic of an earthquake.

17. The method of claim 16, wherein determining the characteristic of the earthquake includes determining at least one of a magnitude or an intensity of the earthquake.

18. The method of claim 16, wherein determining the characteristic of the earthquake includes determining at least one of a location that has been subjected to a high intensity during the earthquake or a direction associated with ground acceleration caused by the earthquake.

19. The method of claim 16, wherein determining the characteristic of the earthquake includes:
determining that the ground acceleration at the first location and the ground acceleration at the second location are similar to ground acceleration data associated with a second earthquake that previously occurred; and
determining that a magnitude of the earthquake is approximately equal to the magnitude of the second earthquake that previously occurred.

20. One or more non-transitory machine-readable media comprising a plurality of machine-readable instructions which when executed by one or more processors associated with a computer-assisted system are adapted to cause the one or more processors to perform the method of claim 16.
